(19) United States
(12) Patent Application Publication
(10) Pub. No.: US 2026/0046374 A1
(43) Pub. Date: Feb. 12, 2026

(54) SELECTION OF CLIENT CONNECTION TYPE IN A VIRTUAL MEETING BASED ON STORED CONFIGURATION INFORMATION

(71) Applicant: Google LLC, Mountain View, CA (US)

(72) Inventor: Stefan Lindmark, Östhammar (SE)

(21) Appl. No.: 18/797,397

(22) Filed: Aug. 7, 2024

(51) Int. Cl. H04N 7/15

(52) U.S. Cl. CPC H04N 7/157; H04N 7/152

(57) ABSTRACT

Systems and methods for selection of client connection type in a virtual meeting based on stored configuration information. In response to a request of a first participant of a virtual meeting platform to join a virtual meeting, a configuration data structure associated with the virtual meeting is accessed. The configuration data structure identifies roles for participants of the virtual meeting. A first role associated with the first participant within the virtual meeting is identified using the configuration data structure. One or more client connection types are assigned to the first participant based on the first role. The first participant is allowed to join the virtual meeting using one of the one or more client connection types.

### TECHNICAL FIELD

Aspects and implementations of the present disclosure relate to selection of client connection type in a virtual meeting based on stored configuration information.

### BACKGROUND

Virtual meetings can take place between multiple participants via a virtual meeting platform. A virtual meeting platform includes tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platforms can provide a user interface to display the video streams of participating client devices.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes selecting client connection types in a virtual meeting based on stored configuration information. In an implementation, the method includes in response to a request of a first participant of a virtual meeting platform to join a virtual meeting, accessing a configuration data structure associated with the virtual meeting. The configuration data structure identifies roles for participants of the virtual meeting. The method further includes identifying, using the configuration data structure, a first role associated with the first participant within the virtual meeting. The method further includes assigning one or more client connection types to the first participant based on the first role. The method further includes allowing the first participant to join the virtual meeting using one of the one or more client connection types.

In some embodiments, the method further includes preventing the first participant from joining the virtual meeting using client connection types other than the one or more client connection types.

In some embodiments, the one or more client connection types include at least one of a client application or a client device providing the first participant with a maximum set of features within the virtual meeting. In some embodiments, the one or more client connection types include at least one of a client application or a client device providing the first participant with a minimum set of features within the virtual meeting.

In some embodiments, the configuration data structure is stored on a server associated with the virtual meeting platform. In some embodiments, the configuration data structure is populated with role data using at least one of input of a user of the virtual meeting platform or an output of an artificial intelligence (AI) model.

In some embodiments, the method further includes updating the configuration data structure to assign a second role to the first participant. responsive to updating the configuration data structure, the method includes reconfiguring features associated with the one of the one or more client connection types to allow the first participant to interact within the virtual meeting according to the second role. In some embodiments, updating the configuration data structure to assign a second role to the first participant is performed in response to an interaction by a host of the virtual meeting or a participant of the virtual meeting with one or more user interface (UI) elements of a virtual meeting UI.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example configuration data structure associated with a virtual meeting, in accordance with implementations of the present disclosure.

FIG. 3 illustrates an example user interface (UI) of a virtual meeting, in accordance with implementations of the present disclosure.

FIG. 4 illustrates updates made to a configuration data structure, in accordance with implementations of the present disclosure.

FIG. 5 depicts a flow diagram of a method for selecting client connection type in a virtual meeting based on stored configuration information, in accordance with implementations of the present disclosure.

FIG. 6 is a block diagram illustrating an exemplary computer system, in accordance with implementations of the present disclosure.

### DETAILED DESCRIPTION

Aspects of the present disclosure relate to selection of client connection type in a virtual meeting based on stored configuration information. A virtual meeting can refer to a virtual meeting during which a client device connected to the virtual meeting platform captures and transmits image data (e.g., collected by a camera of the client device) and/or audio data (e.g., collected by a microphone of the client device) to other client devices connected to the platform. The image data can, in some instances, depict a user or a group of users that are participating in the virtual meeting. The audio data can include, in some instances, an audio recording of audio provided by the user or group of users during the virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting.

A virtual meeting typically allows incoming client connection types that accommodate various client devices and client applications. Client connection types can include various methods and technologies through which participants can join and interact with a virtual meeting. For example, client connection types can correspond to web-based clients, mobile applications, native desktop binaries, conference room hardware, and the like. These client connection types can influence the quality, functionality, and user experience during the virtual meeting. For example, a participant accessing a virtual meeting via a dedicated application installed on a client device (e.g., a desktop, a laptop, etc.) can have access to a full set of features within the virtual meeting. On the other hand, a participant accessing a virtual meeting through a web browser can have access to a limited set of features compared to dedicated applications. Some virtual meeting platforms offer connections for multiple client connection types, where each client connection type depends on the type of conference participation that the end user is looking for. For example, a participant of the virtual meeting can join a regular virtual meeting, join a live streamed version of the meeting, join a low-latency live streamed version of the meeting, join a virtual meeting only to present, and the like. Each of these intentions from the user can have a corresponding client implementation.

In some instances, conventional implementations of virtual meeting platforms can assign client connection types based on the type of device the user uses to connect to the virtual meeting, based on a Uniform Resource Locator (URL) the user uses to connect to the virtual meeting, and/or based on a selection that the user is asked to make while joining the virtual meeting. In some instances, a host can plan ahead to ensure participants join the virtual meeting with a client connection type that supports what the user is intended to achieve in the conference. For example, a host can provide instructions to an external speaker to ensure the external speaker joins the virtual meeting via a client connection type that enables presenting or screen sharing in the virtual meeting. However, conventional solutions can allow speakers to be assigned a client connection type that is not suitable for their role in the virtual meeting. For example, the presenter can join a virtual meeting via a client connection type that does not allow them to present within the virtual meeting by joining the virtual meeting via a certain URL or by selecting a certain join option. As a result, the presenter may leave the virtual meeting, and rejoin the virtual meeting using the correct URL/join option to ensure they are assigned a client connection type that allows them to present in the virtual meeting. Such manual selection of client connection type can be confusing to participants of a virtual meeting and lead to client assignment that is incompatible with participants' roles. As a result, a host may coordinate with participants to ensure they each are using the correct URL/join option to join the virtual meeting, which can unnecessarily increase the overall duration of the virtual meeting.

Aspects of the present disclosure address the above deficiencies and other deficiencies by providing systems and methods for selecting client connection types in a virtual meeting based on configuration information stored in a configuration data structure on a server. The configuration information can identify respective client connection types for various participants of the virtual meeting and be defined programmatically or based on user input. In some implementations, a user (e.g., a host, an administrator, a participant, etc.) of a virtual meeting has an option to provide input to assign roles to participants of a virtual meeting based on what roles each participant is intended to have in the virtual meeting. Participant role data can be stored in a configuration data structure on a server as configuration information for the virtual meeting. In some embodiments, a user can provide input to assign user role information when meeting settings are being configured by interacting with one or more user interface (UI) elements of a virtual meeting platform UI. In some embodiments, roles can be assigned using an output of an artificial intelligence (AI) model, which may be trained using data from previous virtual meetings to predict roles of participants in the current virtual meeting. The data from previous meetings may specify roles (e.g., viewers, speakers, technical production staff, etc.) participants had played in those virtual meetings, and context information related to those virtual meetings (e.g., a number and/or types of participants, subjects or topics discussed, time of day, types of meetings (e.g., a status meeting, a potential client pitch meeting, a company-wide meeting, etc.). The predictions can be stored in a configuration data structure on a server as configuration information for the virtual meeting, or can be first presented to a user (e.g., a host, a participant, etc.) for confirmation or modification.

In an illustrative example, a first participant can be assigned the role of “host”, a second participant can be assigned the role of “speaker,” and a third participant can be assigned a role of “view-only.” Client connection types available to each participant can be decided at runtime of the virtual meeting based on role assignments. Each participant can be allowed access to join the virtual meeting using one or more client connection types that allow them to perform their expected role in the virtual meeting. For example, the first participant assigned the “host” role can be restricted to joining the virtual meeting via a full desktop application, thereby ensuring that the first participant has access to a full set of features that allow them to operate in the virtual meeting within the scope of their assigned role as host. The second participant can be prevented from joining the virtual meeting via client connection types that do not allow speaking within the virtual meeting, thereby ensuring the second participant is able to participate in the virtual meeting commensurate with their assigned speaker role. The third participant assigned the “view-only” role can be restricted to viewing a live-stream of the virtual meeting via client software applications for viewing live streams. Thus, the third participant can easily assume the “view-only” role as viewing a live stream of the virtual meeting is the only option available to them. As such, client connection types are determined server-side based on participant roles.

In some instances, the assigned role can result in a client connection type selected based on a minimum set of features offered, a maximum set of features offered, and/or a combination of maximum and minimum features. For example, a host or a participant can limit functionality available to a particular set of participants to a view-only role. The view-only role can result in one or more client connection types that only allow the particular set of participants to view a live stream of the virtual meeting but not actively participate within the virtual meeting.

Aspects of the present disclosure provide technical advantages over previous solutions. Aspects of the present disclosure can provide additional functionality to a virtual meeting platform to determine client connection types available to participants of a virtual meeting based on stored configuration information. Such additional functionality can result in more efficient use of processing resources utilized to facilitate the connections between client devices by avoiding consumption of computing resources needed to support participants manually selecting client connection types when joining a virtual meeting, thereby resulting in an increase of overall efficiency and a decrease in overall latency of the virtual meeting platform. In addition, as participants can join virtual meetings without a manual selection of client connection types, the process of joining a virtual meeting is smoother and more accessible to users of the virtual meeting platform, thereby improving user experience.

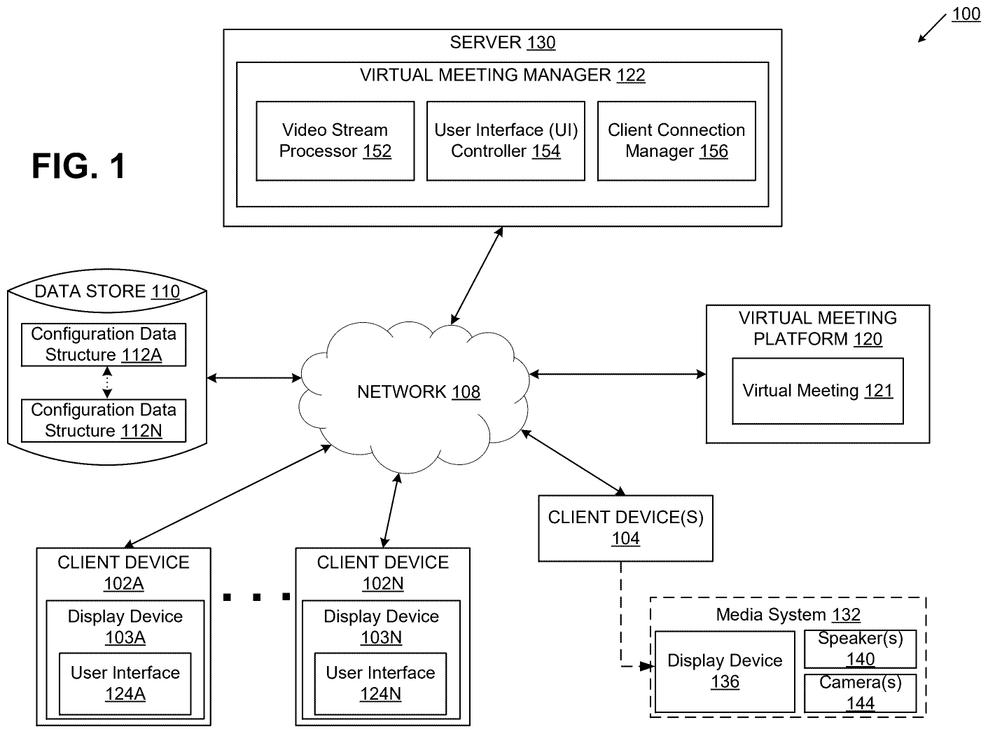

FIG. 1 illustrates an example system architecture 100, in accordance with implementations of the present disclosure. The system architecture 100 (also referred to as “system” herein) includes client devices 102A-N, one or more client devices 104, a data store 110, a virtual meeting platform 120, and a server 130, each connected to a network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments, data store 110 can be some other type of persistent storage such as an object-oriented database, a relational database, and so forth, that can be hosted by virtual meeting platform 120 or one or more different machines (e.g., the server 130) coupled to the virtual meeting platform 120 via network 108. In some implementations, the data store 110 can store portions of audio and video streams received from client devices 102A-102N for the virtual meeting platform 120.

In some implementations, data store 110 can store configuration data structures 112A-112N (also referred to generally as “configuration data structure(s) 112” herein) for the virtual meeting platform 120. Each configuration data structure 112 can be associated with a respective virtual meeting 121 of the virtual meeting platform 120 and can include multiple participants of virtual meeting 121. Configuration data structure 112 can be populated with participant identifiers and corresponding role data for each participant. Role data can refer to information associated with participant roles within the context of virtual meeting 121. Each role can define one or more client connection types usable by corresponding participants to join virtual meeting 121. In some embodiments, a user (e.g., a host, administrator, participant, etc.) of the virtual meeting platform 120 can edit (e.g., add a participant to, update a participant's role, etc.) a respective configuration data structure 112 using, for example, a client device 102A-102N. In some embodiments, a user can provide input to assign user role information when meeting settings are being configured by interacting with one or more user interface (UI) elements of a virtual meeting platform UI.

In some embodiments, roles can be assigned using an output of an AI model, which may be trained using data from previous virtual meetings to predict roles of participants in the current virtual meeting. The data from previous meetings may specify roles (e.g., viewers, speakers, technical production staff, etc.) participants had played in those virtual meetings, and context information related to those virtual meetings (e.g., a number and/or types of participants, subjects or topics discussed, time of day, types of meetings (e.g., a status meeting, a potential client pitch meeting, a company-wide meeting, etc.). For a particular meeting, information about the meeting (e.g., names or identifiers of participants, a subject or topic to be discussed, time of day, a type of the meeting, etc.) can be provided as input to the AI model, which can then produce the output indicating predicted participant roles. For example: when participants A and B are joining the same large meeting, the AI model can predict, based on past meeting participation statistics, that participant A is more likely to talk in meetings overall and be granted one active speaker slot based on a limited availability while participant B can be assigned a viewer-only slot. In another example, the AI model can predict, based on past meeting data, that participant A is more likely to talk in this meeting based on its topic, host, audience, time of day, etc., or a combination of those parameters. In yet another example, the AI model can predict, based on past meeting data, that a participant C, who usually joins meetings as a technical production staff (e.g., a role that does not have a visible video/avatar to others), should have the technical production role if the meeting is external (outside their own team) or the viewer or active role if the meeting is internal (a team meeting or their own staff meeting). The output of the AI model can be used to assign meeting participant roles. Alternatively, the output of the AI model can be provided to a user who can then confirm or modify the role assignments predicted by the AI model.

The AI model can include one or more of decision trees, random forests, support vector machines, or other types of machine learning models. In one embodiment, such AI model may include one or more artificial neural networks (also referred to simply as a neural network). The artificial neural network can include a feature representation component with a classifier or regression layers that map features to a target output space. The artificial neural network may be, for example, a convolutional neural network (CNN) that can include a feature representation component with a classifier or regression layers that map features to a target output space, and can host multiple layers of convolutional filters. Pooling can be performed, and non-linearities may be addressed, at lower layers, on top of which a multi-layer perceptron can be commonly appended, mapping top layer features extracted by the convolutional layers to decisions (e.g., classification outputs). The neural network may further be a deep network with multiple hidden layers or a shallow network with zero or a few (e.g., 1-2) hidden layers. Deep learning may use a cascade of multiple layers of nonlinear processing units for feature extraction and transformation. Each successive layer can use the output from the previous layer as input. In deep learning, each level learns to transform its input data into a slightly more abstract and composite representation. In some embodiments, the AI model can include a generative AI model, such as a large language model (LLM) allowing for the generation of new and original content. A generative AI model may include aspects of a transformer architecture, or a GAN architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks. A generative AI model can be pre-trained on a large corpus of data so as to process, analyze, and generate human-like text based on given input. Any of the AI models may have any typical architecture for LLMs, including one or more architectures as seen in Bidirectional Encoder Representations from Transformers (BERT), Generative Pre-trained Transformer series (Chat GPT series LLMs), or leverage a combination of transformer architecture with pre-trained data to create coherent and contextually relevant text.

In some embodiments, configuration data structure 112 can be stored on a server, such as server 130, and processed by client connection manager 156. In some embodiments, configuration data structure 112 can be stored on one or more associated client devices 102. It is appreciated that the functionality of configuration data structure 112 can be implemented using a variety of data structures. For example, configuration data structure 112 can be implemented as a list, an array, a vector, a set, a linked list, a stack, a queue, a buffer, a tree, a graph, and the like.

Virtual meeting platform 120 can enable users of client devices 102A-102N and/or client device(s) 104 to connect with each other via a virtual meeting (e.g., a virtual meeting 121). A virtual meeting 121 refers to a real-time communication session such as a virtual meeting call, also known as a video-based call or video chat, in which participants can connect with multiple additional participants in real-time and be provided with audio and video capabilities. Real-time communication refers to the ability for participants to communicate (e.g., exchange information) instantly without transmission delays and/or with negligible (e.g., milliseconds or microseconds) latency. Virtual meeting platform 120 can allow a user to join and participate in a virtual meeting 121 with other users of the platform. Embodiments of the present disclosure can be implemented with any number of participants connecting via the virtual meeting 121 (e.g., five hundred or more).

The client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices 102A-102N.” Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102. In some implementations, the audiovisual component can also include an image capture device (e.g., a camera) to capture images and generate video data (e.g., a video stream) of the captured data of the captured images.

In some embodiments, virtual meeting platform 120 is coupled, via network 108, with one or more client devices 104 that are each associated with a physical conference or meeting room. Client device(s) 104 can include or be coupled to a media system 132 that can include one or more display devices 136, one or more speakers 140 and one or more cameras 144. Display device 136 can be, for example, a smart display or a non-smart display (e.g., a display that is not itself configured to connect to network 108). Users that are physically present in the room can use media system 132 rather than their own devices (e.g., client devices 102A-102N) to participate in virtual meeting 121, which can include other remote users. For example, the users in the room that participate in the virtual meeting can control the display device 136 to show a slide presentation or watch slide presentations of other participants. Sound and/or camera control can similarly be performed. Similar to client devices 102A-102N, client device(s) 104 can generate audio and video data to be streamed to virtual meeting platform 120 (e.g., using one or more microphones, speakers 140 and cameras 144).

Each client device 102A-102N or client device(s) 104 can include a browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access virtual meeting platform 120. For example, a user of client device 102A can join and participate in a virtual meeting via a UI 124A presented on the display device 103A by the web browser or client application. A user can also present a document to participants of the virtual meeting via each of the UIs 124A-124N. Each of the UIs 124A-124N can include multiple regions to present video streams corresponding to video streams of the client devices 102A-102N provided to the server 130 for the virtual meeting.

In some implementations, server 130 can include a virtual meeting manager 122. Virtual meeting manager 122 is configured to manage a virtual meeting between multiple users of virtual meeting platform 120. In some implementations, virtual meeting manager 122 can provide the UIs 124A-124N to each client device to enable users to watch and listen to each other during a virtual meeting. Virtual meeting manager 122 can also collect and provide data associated with the virtual meeting to each participant of virtual meeting 121. In some implementations, virtual meeting manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device(s) 104. The native application can be separate from a web browser. In some embodiments, the virtual meeting manager 122 can determine visual items for presentation in the UI 124A-124N during a virtual meeting. A visual item can refer to a UI element that occupies a particular region in the UI and is dedicated to presenting a video stream from a respective client device. Such a video stream can depict, for example, a user of the respective client device while the user is participating in the virtual meeting (e.g., speaking, presenting, listening to other participants, watching other participants, etc., at particular moments during the virtual meeting), a physical conference or meeting room (e.g., with one or more participants present), a document or other media content (e.g., video content, one or more images, etc.) being presented during the virtual meeting, and the like. It is appreciated that providing video streams for presentation is described herein by way of example, and not limitations, noting that aspects and embodiments of the present disclosure can be applied to other visual items (e.g., recorded videos) without deviating from the scope of the present disclosure.

In some implementations, the virtual meeting manager 122 includes a video stream processor 152, a user interface (UI) manager 154, and a client connection manager 156. The components can be combined together or separated into further components, according to a particular implementation. It should be noted that in some implementations, various components of the virtual meeting manager 122 can run on separate machines.

The video stream processor 152 can receive video streams from client devices 102A-102N and/or client device(s) 104. The video stream processor 152 can determine video streams for presentation in the UIs 124A-124N during the virtual meeting 121. Each video stream can correspond to a video stream from a client device (e.g., the video stream pertaining to one or more participants of the virtual meeting). In some implementations, the video stream processor 152 can receive audio streams associated with the video streams from the client devices (e.g., from an audiovisual component of the client devices 102A-102N).

The User Interface (UI) manager 154 can provide a UI for a virtual meeting. The UI can include multiple regions. Each region can display a video stream pertaining to one or more participants of the virtual meeting. The UI manager 154 can control which video stream is to be displayed by providing a command to the client devices that indicates which video stream is to be displayed in which region of the UI (along with the received video and audio streams being provided to the client devices). For example, in response to being notified of the determined video streams for presentation in the UI 124A-124N, the UI manager 154 can transmit a command causing each determined video streams to be displayed in a region of the UI and/or rearranged in the UI.

A participant can join and participate in a virtual meeting via a UI 124A presented on the display device 103A by the web browser or client application. Responsive to receiving a request from the participant to join virtual meeting 121, client connection manager 156 can retrieve role data and corresponding client connection types assigned to the participant from configuration data structure 112. Client connection manager 156 can allow the participant to join virtual meeting 121 using one of the one or more of the assigned client connection types. For example, client connection manager 156 can allow the participant to join the virtual meeting using a client application installed on client device 102. In some embodiments, client connection manager 156 can prevent the participant from joining the virtual meeting 121 using client connection types not assigned to the participant. For example, client connection manager 156 can prevent the participant from joining virtual meeting 121 using a web client.

As described previously, an audiovisual component of each client device can capture images and generate video data (e.g., a video stream) of the captured data of the captured images. In some implementations, the client devices 102A-102N and/or client device(s) 104 can transmit the generated video stream to virtual meeting manager 122. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to virtual meeting manager 122.

In some implementations, virtual meeting platform 120 and/or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a virtual meeting. Virtual meeting platform 120 can also include a website (e.g., a webpage) or application back-end software that may be used to enable a user to connect with other users via virtual meeting 121.

It is appreciated that in some other implementations, the functions of server 130 or virtual meeting platform 120 can be provided by a fewer number of machines. For example, in some implementations, server 130 can be integrated into a single machine, while in other implementations, server 130 can be integrated into multiple machines. In addition, in some implementations, server 130 can be integrated into virtual meeting platform 120.

In general, functions described in implementations as being performed by virtual meeting platform 120 or server 130 can also be performed by the client devices 102A-N and/or client device(s) 104 in other implementations, if appropriate. In addition, the functionality attributed to a particular component can be performed by different or multiple components operating together. Virtual meeting platform 120 and/or server 130 may also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call or conference call between users. Implementations of the disclosure are not limited to virtual meeting platforms that provide virtual meeting tools to users.

In implementations of the disclosure, a “user” can be represented as a single individual. However, other implementations of the disclosure encompass a “user” being an entity controlled by a set of users and/or an automated source. For example, a set of individual users federated as a community in a social network may be considered a “user.” In another example, an automated consumer can be an automated ingestion pipeline, such as a topic channel, of the virtual meeting platform 120.

In situations in which the systems discussed here collect personal information about users, or may make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the virtual meeting platform 120 and/or server 130.

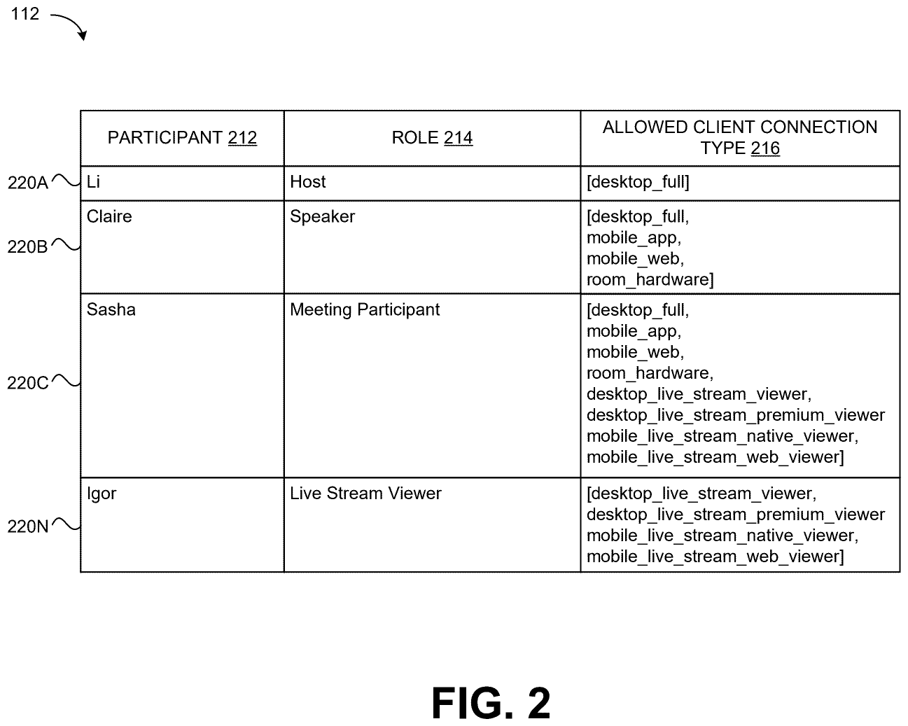

FIG. 2 illustrates an example configuration data structure 112 associated with a virtual meeting, in accordance with implementations of the present disclosure. Configuration data structure 112 can include one or more entries 220A-N (referred to generally as “entries 220” herein) that each correspond to a respective participant of a corresponding virtual meeting. Each entry 220 can include a participant field 212, a role field 214, and an allowed client connection type field 216. Participant field 212 of a respective entry 220 can include an identifier associated with a participant of virtual meeting 121. Role field 212 of a respective entry 220 can include a role of the corresponding participant. Allowed client connection type filed 216 can include one or more client connect types a corresponding participant is allowed to use to access virtual meeting 121. Each role can be associated with one or more allowed client connection types that determine client devices and/or client applications that the participant can use to join virtual meeting 121.

In some embodiments, a role can result in allowed client connection types that offer a maximum set of features. This allows the host to limit functionality available to certain participants. For example, entry 220N corresponds to Igor, a participant of virtual meeting 121. Igor is assigned the role of live stream viewer. Live stream viewers are individuals that are assigned to observe virtual meeting 121 remotely through a streaming platform or dedicated streaming service. Live stream viewers primarily are intended to observe proceedings of the virtual meeting 121 without actively participating in the discussion. Accordingly, Client connection manager 156 can allow Igor (and other participants assigned the live stream viewer role) to join virtual meeting 121 via any of the following client connection types: [desktop_live_stream_viewer, desktop_live_stream_premium_viewer, mobile_live_stream_native_viewer, mobile_live_stream_web_viewer]. Each of these client connection types guarantee a maximum set of features that only allow Igor to attend a live stream of virtual meeting 121. Client connection manager 156 can prevent Igor from joining virtual meeting 121 via any other client connection type.

In some embodiments, a role can result in allowed client connection types that offer a minimum set of features. This guarantees that participants with this role are able to perform expected actions in the virtual meeting. For example, entry 220A corresponds to Li, a participant of virtual meeting 121. Li is assigned the role of host. The role of host can include a variety of responsibilities including setting up virtual meeting 121, managing participants, facilitating the meeting, technical support, and the like. Li is allowed to join virtual meeting 121 using the [desktop_full] client connection type. The [desktop_full] client connection type can include a client application that runs on a specific computing device (e.g., desktop computer, laptop, etc.) and offers the full range of features and functionalities available for the virtual meeting platform 120. These features can include advanced controls (e.g., host controls, breakout rooms, polling, screen sharing, speaking, etc.) that allow Li to carry out their role as host of the virtual meeting 121. Client connection manager 156 can prevent Li from joining virtual meeting 121 via any other client connection type. Accordingly, the assigned client connection types offer a minimum set of features that only allow Li to join and interact with the virtual meeting commensurate with their role as host.

In some embodiments, a role can result in allowed client connection types that offer a combination of minimum set of features and a maximum set of features. For example, entry 220B corresponds to Claire, another participant of virtual meeting 121. Claire is assigned the role of speaker. The role of speaker can include expected responsibilities such as delivering content (e.g., speaking to participants, presenting, etc.), engaging with participants, facilitating discussions, and the like. The host can guarantee that Claire is able to talk and present in virtual meeting 141 by assigning Claire the role of speaker. Client connection manager 156 can allow Claire (and other participants assigned the speaker role) to join virtual meeting 121 via any of the following client connection types: [desktop_full, mobile_app, mobile_web, room_hardware]. Each of these client connection types guarantee a minimum set of features that allow Claire to speak and present within virtual meeting 121 and a maximum set of features that ensure Claire does not have access to features that should only be available to the host. Client connection manager 156 can prevent Claire from joining virtual meeting 121 via any other client connection type. It is appreciated that roles and associated allowed client connection types are used herein by way of example, and not by way of limitation. Any role can be assigned any combination of one or more allowed client connection types without deviating from the scope of the present disclosure.

Client connection manager 156 can use configuration data structure 112 to track allowed client connection types of participants of virtual meeting 121. In some embodiments, information stored within configuration data structure 112 can be determined by a participant (e.g., a host, an administrator, etc.) of virtual meeting 121. During a setup process of virtual meeting 121, the host can populate (e.g., via a client device) configuration data structure 112 to ensure participants are assigned roles commensurate with their responsibilities within the virtual meeting 121. For example, the host can populate the configuration data structure 112 with role data and corresponding client connection types by interacting with one or UI elements of a virtual meeting UI. Responsive to receiving a request from the participant to join virtual meeting 121, client connection manager 156 can query the configuration data structure 112 to determine the role and corresponding client connection types assigned to the participant. Client connection manager 156 can allow the participant to join virtual meeting 121 using one of the one or more of the assigned client connection types, as described above.

In some embodiments, a default can be assigned to each participant that is not assigned a role in configuration data structure 112. For example, participants not expressly assigned a role by a virtual meeting host can be automatically assigned the role of “Meeting Participant” with the following allowed client connection types: [desktop_full, mobile_app, mobile_web, room_hardware, desktop_live_stream_viewer, desktop_live_stream_premium_viewer, mobile_live_stream_native_viewer, mobile_live_stream_web_viewer]. In some embodiments, roles and associated allowed client connection types can be determined dynamically upon joining the virtual meeting base on a threshold number of participants currently in the virtual meeting 121. For example, the first 500 participants to join virtual meeting 121 can be assigned the role of “Meeting Participant” with its associated allowed client connection types. Subsequent participants that join virtual meeting 121 can automatically be assigned the role of “Live Stream Viewer” with its associated allowed client connection types.

In some embodiments, the role data in the configuration data structure 112 can be updated based on input provided by a participant of the virtual meeting, where the participant is not the host of the virtual meeting. For example, such a participant can be assigned a role by the host of the virtual meeting and then provided with an option to self-assign a different role during the virtual meeting according to a list of allowed roles. For example, the participant can join as a live stream viewer and upon discovering that their input may be useful for a topic, self-assign a speaker role. This can be useful for allowing a host-less dynamic role assignment based on participant interactions without explicit host or “moderator” activity, within the bounds of course of what the meeting size allows and what participant roles have been designated as “allowed” or “available”. For example, a participant that has a live stream viewer role and a speaker role may only be able to self-transition between those two roles. If the host needs this participant to help moderate the meeting, then the host may still need to engage to upgrade the participant to that new role as it would not be self-assignable.

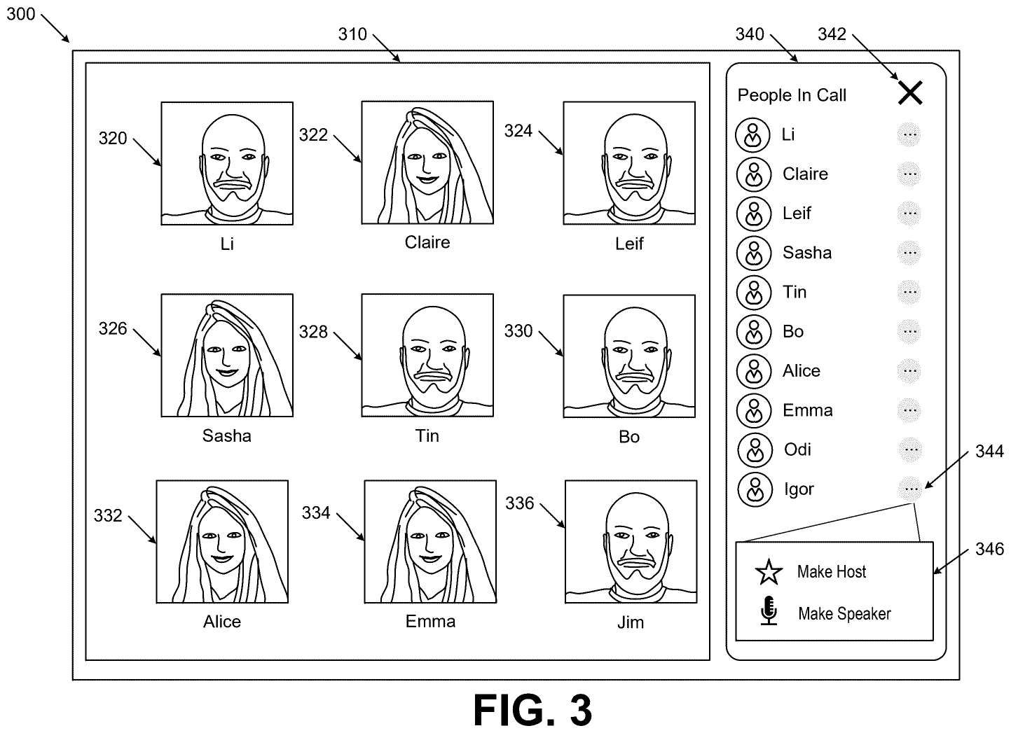

FIG. 3 illustrates an example user interface (UI) 300 for a virtual meeting, in accordance with some embodiments of the present disclosure. The UI 300 can be generated by one or more processing devices of server 130. In some embodiments, the UI 300 can be generated by a virtual meeting manager, such as virtual meeting manager 122 of FIG. 1, for presentation at a client device (e.g., client devices 102A-102N and/or 104). In some embodiments, the virtual meeting between multiple participants can be managed by a virtual meeting platform, such as virtual meeting platform 120 of FIG. 1. As illustrated in FIG. 1, virtual meeting manager 122 can provide the UI 300 to enable participants to join and participate in the virtual meeting.

UI 300 can include multiple regions, including a region 310 to display one or more video streams corresponding to video data captured and/or streamed by client devices, such as client devices 102A-102N of FIG. 1, associated with participants of the virtual meeting, and a scrollable region 340 to display a list of participants of the virtual meeting. It can be noted that a participant of the virtual meeting can be displayed in the list of participants of the virtual meeting within the scrollable region 340 but not displayed within region 310. For example, Odi is a participant of the virtual meeting as indicated by the scrollable region 340, but is not currently displayed within the region 310, as illustrated.

The region 310 can include multiple regions, each to display a video stream corresponding to the video data captured and/or streamed by clients associated with participants of the virtual meeting. In an illustrative example, the region 310 can include a region 320, a region 322, a region 324, a region 326, a region 328, a region 330, a region 332, a region 334, and a region 336. As illustrated, the region 320 can display a video stream corresponding to video data captured and/or streamed by a client device associated with Li, the region 322 can display a video stream corresponding to video data captured and/or streamed by a client device associated with Claire, and so forth.

In some implementations, virtual meeting manager 122 can associate each region with a video stream received from a client device. For example, the processing device can determine that the region 320 is to display a video stream from the client device of Li (e.g., based on an identifier associated with each client device and/or each participant). In some implementations, this can be done automatically without any user input specifying which video stream is to be displayed at the region 320 within the UI 300.

In some embodiments, the user can interact with the UI 300 to cause a modification of a size or a position of video streams displayed within the UI 300. For example, a user can use an input device (e.g., a keyboard, a touch screen etc.) or a cursor device (e.g., a mouse) associated with the client device to cause a modification of the size or the position of the video streams displayed within the UI 300. In some embodiments, a user can cause a modification of the position of the video streams from the region 310 to the region 340 or outside of the UI 201. For example, in response to a user interaction (e.g., via a cursor, a touch screen etc.), Li's video stream can be detached from the UI 301 and moved from region 320 to region 340 and overlay existing UI elements within the region 340. It is appreciated that the user can cause various modifications of video streams. For example, video streams can be resized, moved, zoomed in, cropped, transferred to another display device (e.g., another monitor), or otherwise adjusted to provide a preferred viewing environment. In another example, users can apply filters (e.g., sharpening filters, stylization filters, etc.), add contrast adjustments, or otherwise alter visual aesthetics of video streams according to a user's personal preference.

In some implementations, the UI 300 can also include an options region (not illustrated in FIG. 3) for providing selectable options to adjust display settings (e.g., a size of each region, a number of regions, a selection of a video stream, etc.), invite additional users to participate, etc. In some implementations, the UI 300 can include a UI element (e.g., an icon) (not illustrated in FIG. 3) that corresponds to a self-view indicator, which can indicate to a participant if the participant's video stream is displayed in a region in the UI.

In some implementations, the UI 300 can include a scrollable region 340 to display a list of participants of the virtual meeting. It is noted that a participant of the virtual meeting can be displayed in the list of participants of the virtual meeting within the scrollable region 340 but not displayed within region 310. In an illustrative example, Odi is a participant of the virtual meeting as indicated by the scrollable region 340, but is not currently displayed within the region 310. In some embodiments, the scrollable region 340 can be an expandable/collapsible region. In response to a user interaction with a UI element 342, the processing device may cause the scrollable region 340 to disappear and region 310 to be expanded into the portion of the UI 300 previously occupied by the scrollable region.

In some embodiments, the scrollable region 340 can include an interactable options UI element for each participant displayed within the of the participants. For example, the scrollable region 340 can include an options UI element 344 associated with Igor, a participant of the virtual meeting. In response to a user interaction with the options UI element 344, the processing device can cause an options list 346 to be displayed next to the participant's name. In some embodiments, a user (e.g., a host, an administrator, a participant, etc.) can interact with options list 346 to update pre-configured roles and/or associated allowed client connection type and dynamically reconfigure client behavior according to the updated role. A host can interact with the options list 346 to cause Igor's role to be updated from live stream viewer to speaker. Responsive to a user interaction with a UI element of the options list 346 labeled “Make Speaker,” client connection manager 156 can update Igor's role in the configuration data structure to “Speaker” and update the allowed client connection type to reflect the updated role. In some embodiments, client connection manager 156 can send configuration settings to a client device associated with Igor to alter client behavior. Client connection manager 156 can dynamically (e.g., in real time) enable or disable features on the client based on server-side settings. For example, client connection manager 156 can alter client behavior to allow Igor to speak and/or present within the virtual meeting, thereby allowing Igor to interact with the virtual meeting according to their updated speaker role. In some embodiments, the UI 300 can include controls for user interaction to allow a participant to initiate an update of their role from the list of pre-configured roles without requiring the host to initiate this transition.

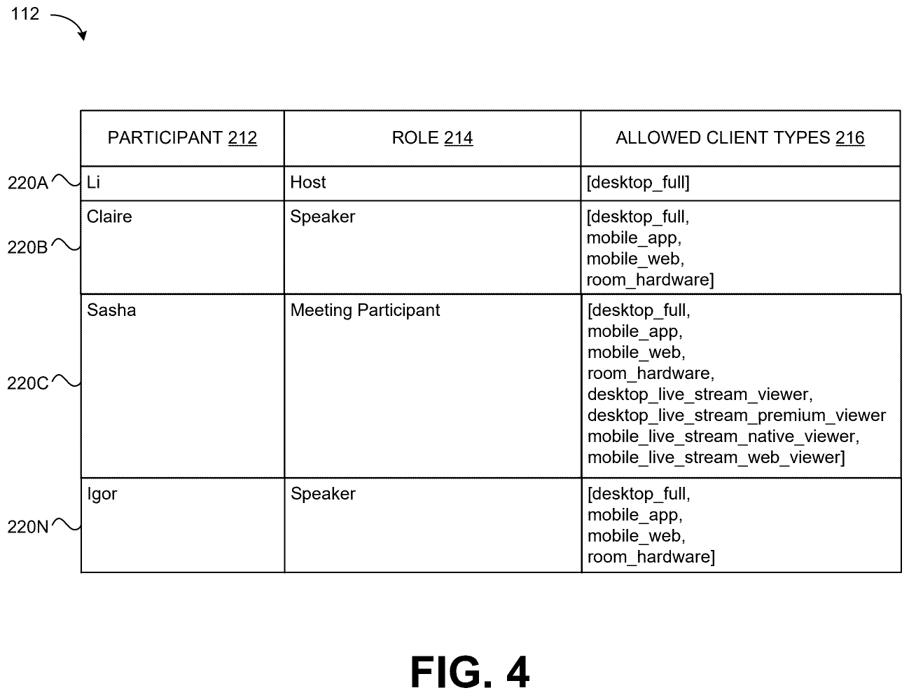

FIG. 4 illustrates updates made to a configuration data structure 112 by a client connection manager 156, in accordance with implementations of the present disclosure. As described above with respect to FIG. 2, configuration data structure 124 can include one or more entries 220 that each correspond to a respective participant of a virtual meeting 121. Responsive to obtaining data (e.g., participant field 212, role field 214, allowed client connection type field 216) for a respective update to at least a portion of configuration data structure 112, client connection manager 156 can update an entry 220 of configuration data structure 124 corresponding to the respective update. For example, Responsive to a user interaction with a UI element of a virtual meeting UI to update Igor's role to “Speaker,” client connection manager 156 can update entry 220N according to the request. Specifically, client connection manager 156 can update role field 214 of entry 220N to “Speaker,” and update allowed client connection type field 216 of entry 220N to the following: [desktop_full, mobile_app, mobile_web, room_hardware].

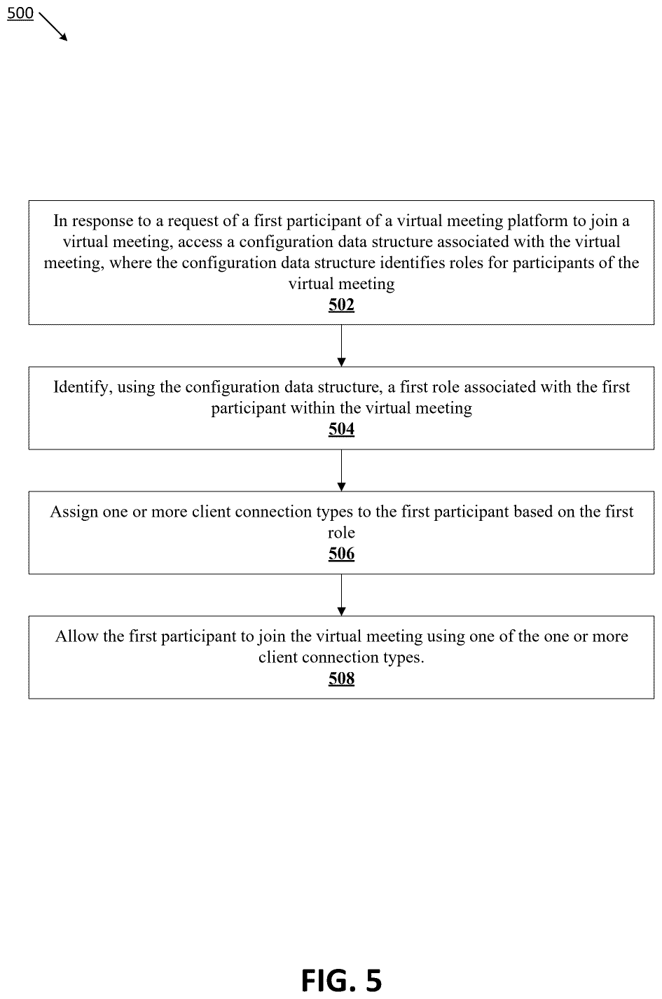

FIG. 5 depicts a flow diagram of a method 500 for selecting client connection type in a virtual meeting based on stored configuration information, in accordance with implementations of the present disclosure. Method 500 can be performed by processing logic that can include hardware (circuitry, dedicated logic, etc.), software (e.g., instructions run on a processing device), firmware, and/or a combination thereof. In one implementation, some or all the operations of method 500 can be performed by one or more components of system 100 of FIG. 1 (e.g., virtual meeting platform 120, server 130 and/or virtual meeting manager 122).

For simplicity of explanation, method 500 of this disclosure is depicted and described as a series of acts. However, acts in accordance with this disclosure can occur in various orders and/or concurrently, and with other acts not presented and described herein. Furthermore, not all illustrated acts can be required to implement method 500 in accordance with the disclosed subject matter. In addition, those skilled in the art will understand and appreciate that method 500 could alternatively be represented as a series of interrelated states via a state diagram or events. Additionally, it should be appreciated that method 500 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 502 of method 500, in response to a request of a first participant of a virtual meeting platform (e.g., virtual meeting platform 120 of FIG. 1) to participate in a virtual meeting (e.g., virtual meeting 121 of FIG. 1), processing logic accesses a configuration data structure (e.g., configuration data structure 112 of FIG. 1) associated with the virtual meeting. The configuration data structure identifies roles for participants of the virtual meeting. In some embodiments, the configuration data structure is stored on a server associated with the virtual meeting platform.

At block 504 of method 500, processing logic identifies, using the configuration data structure, a first role associated with the first participant within the virtual meeting. In some embodiments, the configuration data structure is populated with role data using input of a user of the virtual meeting platform. In some embodiments, the configuration data structure is populated with role data using an output of an AI model, which may be trained using data from previous virtual meetings to predict roles of participants in the current virtual meeting.

At block 506 of method 500, processing logic assigns one or more client connection types to the first participant based on the first role. In some embodiments, configuration data structure can identify respective client connection types for participants of the virtual meeting without associated roles. For example, configuration data structure can directly be populated with client connection data using input of a user.

At block 508 of method 500, processing logic allows the first participant to join the virtual meeting using one of the one or more client connection types. In some embodiments, processing logic can prevent the first participant from joining the virtual meeting using client connection types other than the one or more client connection types. In some embodiments, the one or more client connection types include at least one of a client application or a client device providing the first participant with a maximum set of features within the virtual meeting. In some embodiments, the one or more client connection types include at least one of a client application or a client device providing the first participant with a minimum set of features within the virtual meeting.

In some embodiments, the processing logic is further to update the configuration data structure to assign a second role to the first participant. Responsive to updating the configuration data structure, processing logic can reconfigure features associated with the one of the one or more client connection types to allow the first participant to interact within the virtual meeting according to the second role. In some embodiments, updating the configuration data structure to assign the second role to the first participant is performed in response to an interaction by a host of the virtual meeting with one or more user interface (UI) elements of the virtual meeting.

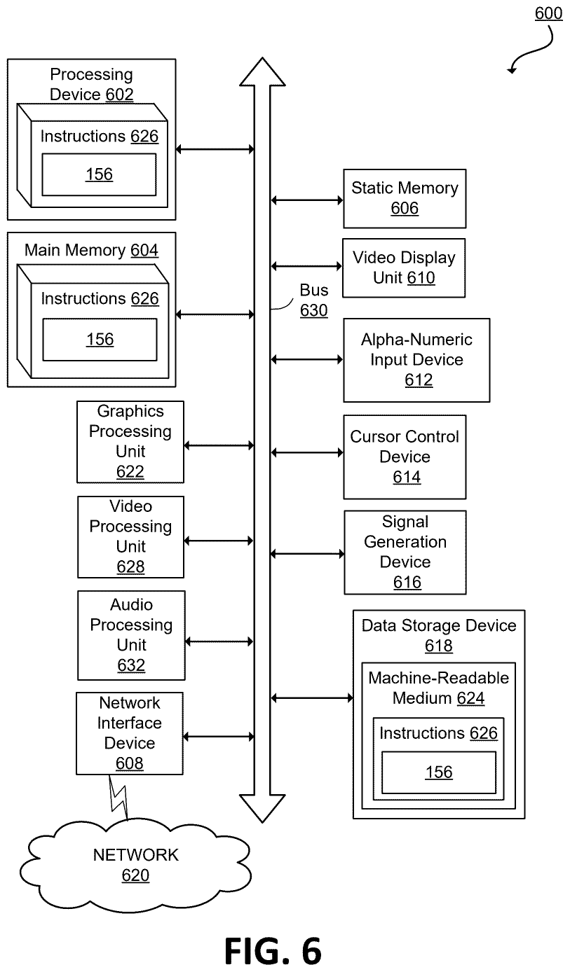

FIG. 6 illustrates an example machine of a computer system 600 within which a set of instructions, for causing the machine to perform any one or more of the methodologies discussed herein, may be executed. The computer system 600 may be server 130 or client devices 102A-N of FIG. 1. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM), a static memory 606 (e.g., flash memory, static random access memory (SRAM), etc.), and a data storage device 618, which communicate with each other via a bus 630.

Processing device 602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 may be configured to execute instructions 626 for performing the operations and steps described herein (e.g., the operations of client connection manager 156).

The computer system 600 may further include a network interface device 608 to communicate over the network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), a graphics processing unit 622, a signal generation device 616 (e.g., a speaker), graphics processing unit 622, video processing unit 628, and audio processing unit 632.

The data storage device 618 may include a machine-readable storage medium 624 (also known as a non-transitory computer-readable storage medium) on which is stored one or more sets of instructions 626 (e.g., the instructions to carry out one or more operations of client connection manager 156) or software embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media.

In some implementations, the instructions 626 include instructions to implement functionality corresponding to the present disclosure. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine, allowing the machine and the processing device 602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform a similar sequence of procedures. In addition, the present disclosure is not described with reference to any particular programming language and any one in use in such computer systems may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element may be depicted in the figures and like elements are labeled with like numerals. The disclosure and drawings are, accordingly, to be regarded in an illustrative sense rather than a restrictive sense.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification may, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” may come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, engines, modules, and so on have been described with respect to interaction between several components and/or blocks. It can be appreciated that such systems, engines, components, blocks, and so forth may include those components or specified sub-components, some of the specified components or sub-components, and/or additional components, and according to various permutations and combinations of the foregoing. Sub-components may also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above. The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
in response to a request of a first participant of a virtual meeting platform to join a virtual meeting, accessing a configuration data structure associated with the virtual meeting, wherein the configuration data structure identifies roles for a plurality of participants of the virtual meeting;
identifying, using the configuration data structure, a first role associated with the first participant within the virtual meeting;
assigning one or more client connection types to the first participant based on the first role; and
allowing the first participant to join the virtual meeting using one of the one or more client connection types.

2. The method of claim 1, further comprising:
preventing the first participant from joining the virtual meeting using client connection types other than the one or more client connection types.

3. The method of claim 1, wherein the one or more client connection types comprise at least one of a client application or a client device providing the first participant with a maximum set of features within the virtual meeting.

4. The method of claim 1, wherein the one or more client connection types comprise at least one of a client application or a client device providing the first participant with a minimum set of features within the virtual meeting.

5. The method of claim 1, wherein the configuration data structure is stored on a server associated with the virtual meeting platform.

6. The method of claim 1, wherein the configuration data structure is populated with role data using at least one of an input of a user of the virtual meeting platform or an output of an artificial intelligence (AI) model.

7. The method of claim 1, further comprising:
updating the configuration data structure to assign a second role to the first participant; and
responsive to updating the configuration data structure, reconfiguring features associated with the one of the one or more client connection types to allow the first participant to interact within the virtual meeting according to second role.

8. The method of claim 7, wherein updating the configuration data structure to assign a second role to the first participant is performed in response to an interaction by a host of the virtual meeting or a participant of the virtual meeting with one or more user interface (UI) elements of a virtual meeting UI.

9. A system comprising:
a memory device; and
a processing device coupled to the memory device, the processing device to perform operations comprising:
in response to a request of a first participant of a virtual meeting platform to join a virtual meeting, accessing a configuration data structure associated with the virtual meeting, wherein the configuration data structure identifies respective client connection types for a plurality of participants of the virtual meeting;
assigning, using the configuration data structure, one or more client connection types to the first participant; and
allowing the first participant to join the virtual meeting using one of the one or more client connections types.

10. The system of claim 9, wherein assigning, using the configuration data structure, one or more client connection types to the first participant comprises:
identifying, using the configuration data structure, a first role associated with the first participant within the virtual meeting; and
assigning the one or more client connection types to the first participant based on the first role.

11. The system of claim 10, further comprising:
updating the configuration data structure to assign a second role to the first participant; and
responsive to updating the configuration data structure, reconfiguring features associated with the one of the one or more client connection types to allow the first participant to interact within the virtual meeting according to the second role.

12. The system of claim 11, wherein updating the configuration data structure to assign a second role to the first participant is performed in response to an interaction by a host of the virtual meeting or a participant of the virtual meeting with one or more user interface (UI) elements of a virtual meeting UI.

13. The system of claim 9, further comprising:
preventing the first participant from joining the virtual meeting using client connection types other than the one or more client connection types.

14. The system of claim 9, wherein the one or more client connection types comprise at least one of a client application or a client device providing the first participant with a maximum set of features within the virtual meeting.

15. The system of claim 9, wherein the one or more client connection types comprise at least one of a client application or a client device providing the first participant with a minimum set of features within the virtual meeting.

16. The system of claim 9, wherein the configuration data structure is stored on a server associated with the virtual meeting platform.

17. The system of claim 9, wherein the configuration data structure is populated with client connection type data using at least one of an input of a user of the virtual meeting platform or an output of an artificial intelligence (AI) model.

18. A non-transitory computer-readable storage medium comprising instructions that, when executed by a processing device, cause the processing device to perform operations comprising:
in response to a request of a first participant of a virtual meeting platform to join a virtual meeting, accessing a configuration data structure associated with the virtual meeting, wherein the configuration data structure identifies roles for a plurality of participants of the virtual meeting;
identifying, using the configuration data structure, a first role associated with the first participant within the virtual meeting;
assigning one or more client connection types to the first participant based on the first role; and
allowing the first participant to join the virtual meeting using one of the one or more client connection types.

19. The non-transitory computer-readable storage medium of claim 18, further comprising:
preventing the first participant from joining the virtual meeting using client connection types other than the one or more client connection types.

20. The non-transitory computer-readable storage medium of claim 18, wherein the one or more client connection types comprise at least one of a client application or a client device providing the first participant with a maximum set of features within the virtual meeting.
